(19) United States
(12) Patent Application Publication
(10) Pub. No.: US 2013/0029034 A1
(43) Pub. Date: Jan. 31, 2013

(54) PROCESS FOR PRODUCING SILVER NANOPARTICLES

(71) Applicants: Ping Liu, Mississauga (CA); Yiliang Wu, Oakville (CA); Sandra J. Gardner, Oakville (CA); Nan-Xing Hu, Oakville (CA); Anthony James Wigglesworth, Oakville (CA)

(72) Inventors: Ping Liu, Mississauga (CA); Yiliang Wu, Oakville (CA); Sandra J. Gardner, Oakville (CA); Nan-Xing Hu, Oakville (CA); Anthony James Wigglesworth, Oakville (CA)

(73) Assignee: Xerox Corporation, Norwalk, CT (US)

(21) Appl. No.: 13/192,668

(22) Filed: Jul. 28, 2011

(51) Int. Cl. B05D 5/12; C22C 5/06; B22F 9/20; B05D 3/02; B82Y 30/00

(52) U.S. Cl. 427/125; 75/370; 420/501; 977/773; 977/810

(57) ABSTRACT

A process for producing silver nanoparticles includes receiving a first mixture comprising a silver salt, an organoamine, a first solvent, and a second solvent; and reacting the first mixture with a reducing agent solution to form organoamine-stabilized silver nanoparticles. The polarity index of the first solvent is less than 3.0, and the polarity index of the second solvent is higher than 3.0. The nanoparticles are more dispersible or soluble in the first solvent.

### BACKGROUND

The present disclosure relates to processes for producing uniform, stable silver nanoparticles.

Fabrication of electronic circuit elements using liquid deposition techniques may be beneficial as such techniques provide potentially low-cost alternatives to conventional mainstream amorphous silicon technologies for electronic applications such as thin-film transistors (TFTs), light-emitting diodes (LEDs), RFID tags, photovoltaics, etc. However, the deposition and/or patterning of functional electrodes, pixel pads, and conductive traces, lines and tracks which meet the conductivity, processing, and cost requirements for practical applications have been a great challenge. The metal, silver (Ag), is of particular interest as conductive elements for electronic devices because silver is much lower in cost than gold (Au) and it possesses much better environmental stability than copper (Cu).

Prior methods for producing silver nanoparticles used excessive amounts of stabilizer. In addition, the resultant products were typically irregular and unstable. As a result, the products experienced particle aggregation and shorter shelf lives.

There is therefore a critical need, addressed by embodiments of the present disclosure, for lower cost methods for preparing liquid processable, stable silver-containing nanoparticle compositions that are suitable for fabricating electrically conductive elements of electronic devices.

### BRIEF DESCRIPTION

Disclosed in various embodiments are processes for producing silver nanoparticles. The processes include the use of a mixture of two types of solvent. The silver nanoparticles are usually dispersible in the first solvent and are not dispersible in the second solvent.

Disclosed in embodiments is a process for producing organoamine-stabilized silver nanoparticles. A first mixture including a silver salt, an organoamine, a first organic solvent, and a second organic solvent is received. The first mixture is reacted with a reducing agent to form organoamine-stabilized silver nanoparticles. The reducing agent can be diluted with the first solvent, the second solvent, or a mixture thereof. The first solvent has a polarity index of 3.0 or lower, and the second solvent has a polarity index higher than 3.0. The organoamine-stabilized silver nanoparticles are more dispersible in the first solvent than the second solvent.

In some embodiments, the first solvent has a polarity index of 2.5 or lower, and the second solvent has a polarity index of 3.5 or higher. In other embodiments, the difference in the polarity index between the first solvent and the second solvent is at least 2.0.

The first solvent may be a hydrocarbon selected from the group consisting of decalin, toluene, xylene, bicyclohexyl, and mixtures thereof. The second solvent may be selected from the group consisting of methanol, ethanol, n-propanol, isopropanol, n-butanol, isobutanol, methyl ethyl ketone, ethyl acetate, tetrahydrofuran, 1,4-dioxane, and mixtures thereof. In some specific embodiments, the first solvent is decalin and the second solvent is methanol.

The volume ratio of the first solvent to the second solvent in the first mixture may be from about 1:1 to about 10:1.

The organoamine may be selected from the group consisting of propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, N,N-dimethylamine, N,N-dipropylamine, N,N-dibutylamine, N,N-dipentylamine, N,N-dihexylamine, N,N-diheptylamine, N,N-dioctylamine, N,N-dinonylamine, N,N-didecylamine, N,N-diundecylamine, N,N-didodecylamine, methylpropylamine, ethylpropylamine, propylbutylamine, ethylbutylamine, ethylpentylamine, propylpentylamine, butylpentylamine, triethylamine, tripropylamine, tributylamine, tripentylamine, trihexylamine, triheptylamine, trioctylamine, 1,2-ethylenediamine, N,N,N′,N′-tetramethylethylenediamine, propane-1,3-diamine, N,N,N′,N′-tetramethylpropane-1,3-diamine, butane-1,4-diamine, and N,N,N′,N′-tetramethylbutane-1,4-diamine, and the like, or mixtures thereof.

The reaction may occur at a temperature of from about −30° C. to about 65° C., including at a temperature of about 40° C.

The reducing agent may be a hydrazine compound. The hydrazine compound may have the structure

R¹R²N—NR³R⁴

wherein R⁴, R², R³ and R⁴ are independently selected from hydrogen, alkyl and aryl.

The molar ratio of the organoamine to the silver salt in the first mixture may be from about 1:1 to about 10:1. More specifically, the molar ratio of the organoamine to the silver salt may be from about 1:1 to about 5:1.

The silver salt may be selected from the group consisting of silver acetate, silver nitrate, silver oxide, silver acetylacetonate, silver benzoate, silver bromate, silver bromide, silver carbonate, silver chloride, silver citrate, silver fluoride, silver iodate, silver iodide, silver lactate, silver nitrite, silver perchlorate, silver phosphate, silver sulfate, silver sulfide, and silver trifluoroacetate.

The standard deviation of the particle size of the organoamine-stabilized silver nanoparticles may be less than about 3 nm. More specifically, the standard deviation of the particle size of the organoamine-stabilized silver nanoparticles may be less than about 2.5 nm.

Also disclosed is a process for producing organoamine-stabilized silver nanoparticles. A starting mixture comprising a silver salt, an organoamine, a first organic solvent, and a second organic solvent is received. The first solvent has a polarity index of 3.0 or lower, and the second solvent has a polarity index higher than 3.0. The second solvent in the starting mixture can be received during the addition of a reducing agent which is diluted in the second solvent alone or a mixture of the first solvent and second solvent. The reducing agent is added to the starting mixture to form a reaction mixture that forms organoamine-stabilized silver nanoparticles. The organoamine-stabilized silver nanoparticles are precipitated by adding an additional amount of the second solvent to form a final mixture. The organoamine-stabilized silver nanoparticles are more dispersible in the first solvent than in the second solvent. The standard deviation of the particle size of the organoamine-stabilized silver nanoparticles may be less than about 3 nm. More specifically, the standard deviation of the particle size of the organoamine-stabilized silver nanoparticles may be less than about 2.5 nm. The organoamine-stabilized silver nanoparticles may have an average particle size of from about 7 to about 10 nm.

Further disclosed is a process for producing a conductive element. The process includes annealing a composition comprising organoamine-stabilized silver nanoparticles at a temperature of from about 60° C. to about 140° C. More specifically, the annealing temperature may be from about 60° C. to 80° C. The organoamine-stabilized silver nanoparticles are produced by the methods disclosed herein and above.

These and other non-limiting characteristics of the disclosure are more particularly disclosed below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 represents a first embodiment of a thin-film transistor fabricated according to the present disclosure.

FIG. 2 represents a second embodiment of a thin-film transistor fabricated according to the present disclosure.

FIG. 3 represents a third embodiment of a thin-film transistor fabricated according to the present disclosure.

FIG. 4 represents a fourth embodiment of a thin-film transistor fabricated according to the present disclosure.

FIG. 5 is an image of lines printed with a composition produced by an exemplary process of the present disclosure.

FIG. 6A is a TEM image of silver nanoparticles produced by an exemplary process of the present disclosure.

FIG. 6B is a TEM image of silver nanoparticles produced by a previously known process.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “nano” as used in “silver nanoparticles” indicates a particle size of less than about 1000 nm. In embodiments, the silver nanoparticles have a particle size of from about 0.5 nm to about 1000 nm, from about 1 nm to about 500 nm, from about 1 nm to about 100 nm, and particularly from about 1 nm to about 20 nm. The particle size is defined herein as the average diameter of the silver nanoparticles, as determined by TEM (transmission electron microscopy).

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

The present disclosure relates to processes for forming silver nanoparticles. Generally, a first or starting mixture is made that contains a silver salt, an organoamine, a first organic solvent, and a second organic solvent. The first mixture is reacted with a reducing agent to form organoamine-stabilized silver nanoparticles. The organoamine-stabilized stabilized silver nanoparticles are more dispersible in the first solvent than the second solvent. The resulting nanoparticles are more uniform in size, as seen by a reduced standard deviation in the particle size. In addition, the nanoparticles can be annealed at lower temperatures to form conductive elements with good conductivity.

Exemplary silver salts include silver acetate, silver nitrate, silver oxide, silver acetylacetonate, silver benzoate, silver bromate, silver bromide, silver carbonate, silver chloride, silver citrate, silver fluoride, silver iodate, silver iodide, silver lactate, silver nitrite, silver perchlorate, silver phosphate, silver sulfate, silver sulfide, and silver trifluoroacetate. The silver salt particles are desirably fine for homogeneous dispersion in the solution, which aids in efficient reaction.

In embodiments, the resulting silver nanoparticles are composed of elemental silver or a silver composite. Thus, besides silver, the silver composite may include either or both of (i) one or more other metals and (ii) one or more non-metals. Suitable other metals include, for example, Al, Au, Pt, Pd, Cu, Co, Cr, In, and Ni, particularly the transition metals, for example, Au, Pt, Pd, Cu, Cr, Ni, and mixtures thereof. Exemplary metal composites are Au—Ag, Ag—Cu, Au—Ag—Cu, and Au—Ag—Pd. Suitable non-metals in the metal composite include, for example, Si, C, and Ge. The various components of the silver composite may be present in an amount ranging for example from about 0.01% to about 99.9% by weight, particularly from about 10% to about 90% by weight. In embodiments, the silver composite is a metal alloy composed of silver and one, two or more other metals, with silver comprising, for example, at least about 20% of the nanoparticles by weight, particularly greater than about 50% of the nanoparticles by weight, including from about 50% to about 95%, preferably from about 60% to about 95% by weight, or from about 70% to about 95% by weight. The content can be analyzed with any suitable method. For example, the silver content can be obtained from TGA analysis or ash method. Thus, the first mixture may also contain other metal salts needed to form the silver composite, if desired.

The organoamine acts as a stabilizer for the nanoparticles, and may be a primary, secondary, or tertiary amine. Exemplary organoamines include propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, N,N-dimethylamine, N,N-dipropylamine, N,N-dibutylamine, N,N-dipentylamine, N,N-dihexylamine, N,N-diheptylamine, N,N-dioctylamine, N,N-dinonylamine, N,N-didecylamine, N,N-diundecylamine, N,N-didodecylamine, methylpropylamine, ethylpropylamine, propylbutylamine, ethylbutylamine, ethylpentylamine, propylpentylamine, butylpentylamine, triethylamine, tripropylamine, tributylamine, tripentylamine, trihexylamine, triheptylamine, trioctylamine, 1,2-ethylenediamine, N,N,N′,N′-tetramethylethylenediamine, propane-1,3-diamine, N,N,N′,N′-tetramethylpropane-1,3-diamine, butane-1,4-diamine, and N,N,N′,N′-tetramethylbutane-1,4-diamine, and the like, or mixtures thereof. In specific embodiments, the silver nanoparticles are stabilized with dodecylamine, tridecylamine, tetradecylamine, pentadecylamine, or hexadecylamine.

The reducing agent is, in specific embodiments, a hydrazine compound. The hydrazine compound may have the formula:

R¹R²N—NR³R⁴

wherein R¹, R², R³, and R⁴ are independently selected from hydrogen, alkyl, and aryl. In more specific embodiments, the hydrazine compound is of the formula R¹R²N—NH₂, where at least one of R¹ and R² is not hydrogen. Exemplary hydrazine compounds include phenylhydrazine.

The first organic solvent is less polar than the second organic solvent used in the first or starting mixture. This first solvent can facilitate the dispersion of the unstabilized or stabilized metal nanoparticles formed during the reaction process. In embodiments, the polarity index (PI) of the first organic solvent is 3.0 or lower. The polarity index is a measure of the intermolecular attraction between a solute and a solvent, and is different from and does not correlate with the Hildebrand solubility parameter.

The first organic solvent may be a hydrocarbon containing from about 6 to about 28 carbon atoms, which may be substituted or unsubstituted, and be an aliphatic or aromatic hydrocarbon. It should be noted that not all hydrocarbons have a polarity index of 3.0 or lower. Exemplary hydrocarbons may include aliphatic hydrocarbons such as heptane (PI=0.0), undecane, dodecane, tridecane, tetradecane, isoparaffinic hydrocarbons such as isodecane, isododecane, and commercially available mixtures of isoparaffins such as ISOPAR E, ISOPAR G, ISOPAR H, ISOPAR L and ISOPAR M (all the above-mentioned manufactured by Exxon Chemical Company), and the like; cyclic aliphatic hydrocarbons such as bicyclopropyl, bicyclopentyl, bicyclohexyl, cyclopentylcyclohexane, spiro[2,2]heptane, bicyclo[4,2,0]octanehydroindane, decahydronaphthalene (i.e. bicyclo[4.4.0]decane or decalin), and the like; aromatic hydrocarbons such as toluene (PI=2.3-2.4), benzene (P1=2.7-3), chlorobenzene (PI=2.7), o-dichlorobenzene(PI=2.7); and mixtures thereof.

In particular embodiments, the first organic solvent is a hydrocarbon selected from the group consisting of toluene, xylene, decalin, bicyclohexyl, and mixtures thereof. Toluene has a polarity index of 2.3-2.4, and xylene has a polarity index of 2.4-2.5. Decalin and bicyclohexyl are estimated to have a polarity index of between 0.2 and 0.5. In more specific embodiments, the first organic solvent is decalin, which is also known as decahydronaphthalene and has the formula C₁₀H₁₈. The first solvent may also be a mixture of one, two, three or more solvents which are soluble with each other, and which have the properties discussed below. In such mixtures, each solvent may be present at any suitable volume ratio or mass ratio. In this regard, the term “miscible” typically refers to two liquids being soluble in all proportions, and this is not required of the various solvents that can be used as the first solvent.

The second organic solvent is more polar than the first organic solvent. The second solvent should also have good solubility with the reducing agent (which is typically in a liquid form). In embodiments, the polarity index of the second organic solvent is higher than 3.0. Exemplary second solvents include an alcohol, ether, ketone, ester, methylene chloride (PI=3.4), and mixtures thereof. It should be noted that not all alcohols, ethers, ketones, and esters have a polarity index higher than 3.0. Exemplary alcohols include methanol (PI=5.1-6.6), ethanol (PI=5.2), n-propanol (PI=4.0-4.3), n-butanol (PI=3.9-4.0), isobutyl alcohol (PI=3.9), isopropyl alcohol (PI=3.9-4.3), 2-methoxyethanol (PI=5.7), and the like. Exemplary ethers include tetrahydrofuran (THF) (PI=4.0-4.2), dioxane (PI=4.8) and the like. Exemplary ketones include acetone (PI=5.1-5.4), methyl ethyl ketone (PI=4.5-4.7), methyl n-propyl ketone (PI=4.5), methyl isobutyl ketone (PI=4.2), and the like. Exemplary esters include ethyl acetate (PI=4.3-4.4), methyl acetate (PI=4.4), n-butyl acetate (PI=4.0), and the like. In specific embodiments, the second solvent is selected from the group consisting of methanol, ethanol, n-propanol, isopropanol, n-butanol, isobutanol, methyl ethyl ketone, ethyl acetate, tetrahydrofuran, 1,4-dioxane, and mixtures thereof. In some embodiments, the second solvent is methanol. The second solvent may have a lower boiling temperature relative to the boiling temperature of the first solvent. Desirably, the second solvent has a boiling temperature of 80° C. or less. Again, the second solvent may also be a mixture of one, two, three or more solvents which are soluble with each other, and which have the properties discussed below. In such mixtures, each solvent may be present at any suitable volume ratio or mass ratio.

The first type of solvent and second type of solvent are usually not soluble with each other. Put another way, when mixed together, the first and second types of solvent separate into two visually detectable phases.

Dispersity or solubility is typically measured in terms of concentration, i.e. weight per volume. In embodiments, the silver nanoparticles have a dispersity or solubility of at least 0.2 g/cm³ in the first solvent. In particular embodiments, the silver nanoparticles are not insoluble or dispersible (i.e. immiscible) in the second solvent.

Use of the dual-solvent system of the present disclosure permits a considerable reduction in the amount of organoamine needed to form the organoamine-stabilized silver nanoparticles. This reduction in the amount of organoamine also reduces the total amount of solvent required, reduces costs and alleviates some disposal concerns. Thus, the disclosed processes are also environmentally friendly.

In some specific embodiments, the first organic solvent has a polarity index of 2.5 or lower, and the second organic solvent has a polarity index of 3.5 or higher. In other embodiments, the difference in the polarity index between the first solvent and the second solvent is at least 2.0. Put another way, the polarity index of the second solvent minus the polarity index of the first solvent is 2.0 or greater.

The molar ratio of the organoamine to the silver salt in the first mixture may be from about 1:1 to about 10:1. In some embodiments, the molar ratio may be from about 1:1 to about 3:1. In the first mixture, the volume ratio of the first solvent he second solvent may be from about 1:1 to about 10:1.

When the reducing agent is added to the first mixture, it is typically diluted in a solvent. The solvent in which the reducing agent is diluted is typically the second type of solvent. The reaction to form silver nanoparticles may occur at a temperature of from about minus 30° C. to about plus 65° C. (i.e. about −30° C. to about +65° C.). After the reaction is complete, an additional amount of the second type of solvent can be added to precipitate the organoamine-stabilized silver nanoparticles. Generally, the total amount of the second type of solvent in the final mixture is greater than the amount of the first type of solvent in the final mixture; this encourages precipitation. In embodiments, the final volume ratio of the first type of solvent to the second type of solvent may be from about 1:2 to about 1:5.

The silver nanoparticles formed by the disclosed processes exhibit improved shape and size uniformity. In particular, the nanoparticles exhibit a more consistently round shape. Inks comprising the nanoparticles show improved jettability due at least in part to the improved size, shape, and uniformity of the nanoparticles. Inks comprising the nanoparticles also exhibit good stability, easy jetting, and no black spots even after 3.5 months of aging. The lack of black spots indicates that particle aggregation is reduced or eliminated by producing the nanoparticles by the disclosed processes. Reduced annealing temperatures can be used with nanoparticles produced according to the present disclosure without sacrificing conductivity. In particular, annealing temperatures of about 60° C. to about 140° C. can be used, whereas temperatures of about 120° C. to 180° C. are commonly required for other nanoparticle compositions. In particular embodiments, the annealing temperature can be from about 60° C. to about 80° C. The disclosed processes also reduce the amount of organoamine required to stabilize the nanoparticles. Consequently, the total amount of solvent may also be reduced and the processes can be considered “green”.

The particle size of the silver nanoparticles is determined by the average diameter of the particles. The silver nanoparticles may have an average diameter of about 100 nanometers or less, preferably 20 nanometers or less. In some specific embodiments, the nanoparticles have an average diameter of from about 1 nanometer to about 15 nanometers, including from about 3 nanometers to about 10 nanometers. In addition, the silver nanoparticles have a very uniform particle size with a narrow particle size distribution. The particle size distribution can be quantified using the standard deviation of the average particle size. In embodiments, the silver nanoparticles have a narrow particle size distribution with an average particle size standard deviation of 3 nm or less, including 2.5 nm or less. In some embodiments, the silver nanoparticles have an average particle size of from about 1 nanometer to about 10 nanometers with a standard deviation of from about 1 nanometer to about 3 nanometers. Without being limited by theory, it is believed that small particle sizes with a narrow particle size distribution make the nanoparticles easier to disperse when placed in a solvent, and can offer a more uniform coating on the object due to the self-assembly of the uniform silver nanoparticles.

In embodiments, further processing of the silver nanoparticles (with the organoamine on the surface thereof) may occur such as, for example, making them compatible with a liquid deposition technique (e.g., for fabricating an electronic device). Such further processing of the composition may be, for instance, dissolving or dispersing the silver-containing nanoparticles in an appropriate liquid.

The silver nanoparticles can be dispersed or dissolved in a solvent to form a silver nanoparticle composition that can be used as a liquid deposition solution. Silver nanoparticles are highly dispersible in the solvent. In embodiments, the silver nanoparticle composition contains from about 5 weight percent to about 80 weight percent (wt %) of the silver nanoparticles, including from about 5 weight percent to about 60 weight percent of the silver nanoparticle, or from about 8 wt % to about 40 wt %, or from about 10 wt % to about 20 wt %.

Any suitable solvent having a polarity index of 3.0 or less can be used to dissolve or to disperse the silver nanoparticles, including a hydrocarbon, a heteroatom-containing aromatic compound, an alcohol, and the like. Again, not all hydrocarbons, heteroatom-containing aromatic compounds, and alcohols necessarily have a polarity index of 3.0 or less. Exemplary heteroatom-containing aromatic compounds include chlorobenzene, chlorotoluene, dichlorobenzene, and nitrotoluene. In embodiments, the solvent is a hydrocarbon solvent containing about 6 carbon atoms to about 28 carbon atoms, such as an aromatic hydrocarbon containing from about 7 to about 18 carbon atoms, a linear or a branched aliphatic hydrocarbon containing from about 8 to about 28 carbon atoms, or a cyclic aliphatic hydrocarbon containing from about 6 to about 28 carbon atoms. In other embodiments, the solvent can be a monocyclic or a polycyclic hydrocarbon. Monocyclic solvents include a cyclic terpene, a cyclic terpinene, and a substituted cyclohexane. Polycyclic solvents include compounds having separate ring systems, combined ring systems, fused ring systems, and bridged ring systems. In embodiments, the polycyclic solvent includes bicyclopropyl, bicyclopentyl, bicyclohexyl, cyclopentylcyclohexane, spiro[2,2]heptane, spiro[2,3]hexane, spiro[2,4]heptane, spiro[3,3]heptane, spiro[3,4]octane, bicyclo[4,2,0]octanehydroindane, decahydronaphthalene (bicyclo[4.4.0]decane or decalin), perhydrophenanthroline, perhydroanthracene, norpinane, norbornane, bicyclo[2,2,1]octane and so on. Other exemplary solvents may include, but are not limited to, hexane, dodecane, tetradecane, hexadecane, octadecane, an isoparaffinic hydrocarbon, toluene, xylene, mesitylene, diethylbenzene, trimethylbenzene, tetraline, hexalin, decalin, a cyclic terpene, cyclodecene, 1-phenyl-1-cyclohexene, 1-tert-butyl-1-cyclohexene, methyl naphthalene and mixtures thereof. The term “cyclic terpene” includes monocyclic monoterpenes such as limonene, selinene, terpinolene, and terpineol; bicyclic monoterpenes such as α-pinene; and cyclic terpinenes such as γ-terpinene and α-terpinene. The term “isoparaffinic hydrocarbon” refers to a branched chain alkane. Exemplary alcohols include terpineols such as alpha-terpineol, beta-terpineol, gamma-terpineol, and mixtures thereof.

Desirably, the solvent used to dissolve the silver nanoparticles is a low surface tension solvent. In this regard, surface tension can be measured in units of force per unit length (newtons per meter), energy per unit area (joules/square meter), or the contact angle between the solvent and a glass surface. A low surface tension solvent has a surface tension of less than 35 mN/m, including less than 33 mN/m, less than 30 mN/m, or less than 28 mN/m In specific embodiments, the solvent used in the silver nanoparticle composition is decalin, dodecane, tetradecane, hexadecane, bicyclohexane, an isoparaffinic hydrocarbon, and the like.

Some low surface tension additives can be added into the liquid deposition solution to lower the surface tension of the liquid composition for uniform coating. In some embodiments, the low surface tension additive is a modified polysiloxane. The modified polysiloxane may be a polyether modified acrylic functional polysiloxane, a polyether-polyester modified hydroxyl functional polysiloxane, or a polyacrylate modified hydroxyl functional polysiloxane. Exemplary low surface tension additives include SILCLEAN additives available from BYK. BYK-SILCLEAN 3700 is a hydroxyl-functional silicone modified polyacrylate in a methoxypropylacetate solvent. BYK-SILCLEAN 3710 is a polyether modified acryl functional polydimethylsiloxane. BYK-SILCLEAN 3720 is a polyether modified hydroxyl functional polydimethylsiloxane in a methoxypropanol solvent. In other embodiments, the low surface tension additive is a fluorocarbon modified polymer, a small molecular fluorocarbon compound, a polymeric fluorocarbon compound, and the like. Exemplary fluorocarbon modified molecular or polymeric additives include a fluoroalkylcarboxylic acid, Efka®-3277, Efka®-3600, Efka®-3777, AFCONA-3037, AFCONA-3772, AFCONA-3777, AFCONA-3700, and the like. In other embodiments, the low surface tension additive is an acrylate copolymer. Exemplary acrylate polymer or copolymer additives include Disparlon® additives from King Industries such as Disparlon® L-1984, Disparlon® LAP-10, Disparlon® LAP-20, and the like. The amount of the low surface tension additive may be from about 0.0001wt % to about 3 wt %, including from about 0.001wt % to about 1 wt %, or from about 0.001 wt % to about 0.5 wt %.

In embodiments, the liquid silver nanoparticle composition comprising the silver nanoparticles has a low surface tension, for example, less than 32 mN/m, including less than 30 mN/m, or less than 28 mN/m, or less than 25 mN/m. In specific embodiments, the liquid composition has a surface tension from about 22 mN/m to about 28 mN/m, including from about 22 mN/m to about 25 mN/m. The low surface tension can be achieved by using silver nanoparticles with a low polarity surface, by dissolving/dispersing silver nanoparticles in a low surface tension solvent, or by adding a low surface tension additive such as a leveling agent, or combinations thereof.

The fabrication of conductive elements from the silver nanoparticles can be carried out in embodiments using any suitable liquid deposition technique including i) printing such as screen/stencil printing, stamping, microcontact printing, ink jet printing and the like, and ii) coating such as spin-coating, dip coating, blade coating, casting, dipping, and the like. The deposited silver nanoparticles at this stage may or may not exhibit electrical conductivity.

The resulting conductive elements can be used as conductive electrodes, conductive pads, conductive lines, conductive tracks, and the like in electronic devices such as thin-film transistor, organic light emitting diodes, RFID (radio frequency identification) tags, photovoltaic, and other electronic devices which require conductive elements or components. In some embodiments, the conductive elements are used in thin-film transistors.

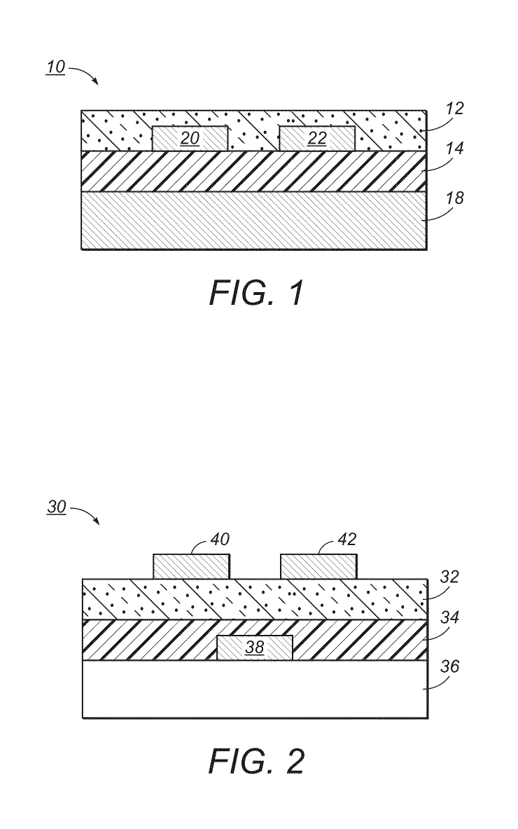

In FIG. 1, there is schematically illustrated a thin-film transistor configuration 10 comprised of a heavily n-doped silicon wafer 18 which acts as both a substrate and a gate electrode, a thermally grown silicon oxide insulating dielectric layer 14 on top of which are deposited two metal contacts, source electrode 20 and drain electrode 22. Over and between the metal contacts 20 and 22 is a semiconductor layer 12 as illustrated herein.

FIG. 2 schematically illustrates another thin-film transistor configuration 30 comprised of a substrate 36, a gate electrode 38, a source electrode 40 and a drain electrode 42, an insulating dielectric layer 34, and a semiconductor layer 32.

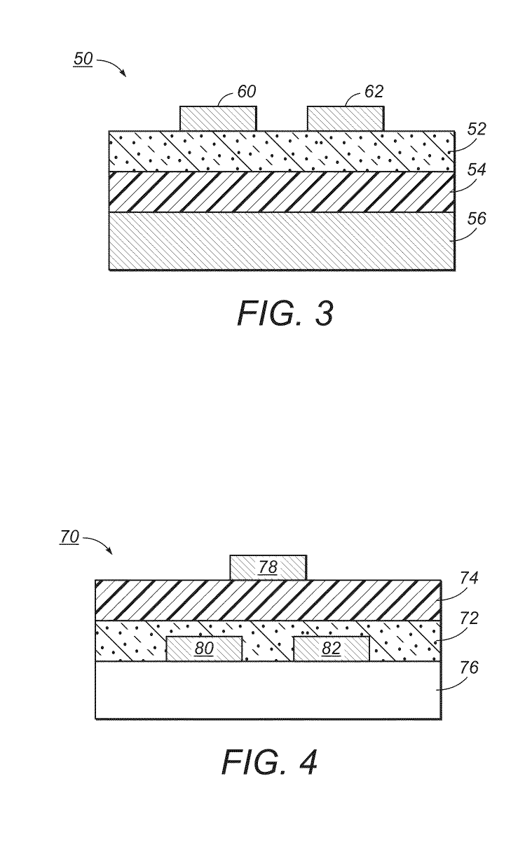

FIG. 3 schematically illustrates a further thin-film transistor configuration 50 comprised of a heavily n-doped silicon wafer 56 which acts as both a substrate and a gate electrode, a thermally grown silicon oxide insulating dielectric layer 54, and a semiconductor layer 52, on top of which are deposited a source electrode 60 and a drain electrode 62.

FIG. 4 schematically illustrates an additional thin-film transistor configuration 70 comprised of substrate 76, a gate electrode 78, a source electrode 80, a drain electrode 82, a semiconductor layer 72, and an insulating dielectric layer 74.

The substrate may be composed of, for instance, silicon, glass plate, plastic film or sheet. For structurally flexible devices, plastic substrate, such as for example polyester, polycarbonate, polyimide sheets and the like may be used. The thickness of the substrate may be from amount 10 micrometers to over 10 millimeters with an exemplary thickness being from about 50 micrometers to about 2 millimeters, especially for a flexible plastic substrate and from about 0.4 to about 10 millimeters for a rigid substrate such as glass or silicon.

The gate electrode, the source electrode, and/or the drain electrode are fabricated by embodiments of the present disclosure. The thickness of the gate electrode layer ranges for example from about 10 to about 2000 nm. Typical thicknesses of source and drain electrodes are, for example, from about 40 nm to about 1 micrometer with the more specific thickness being about 60 to about 400 nm.

The insulating dielectric layer generally can be an inorganic material film or an organic polymer film. Illustrative examples of inorganic materials suitable as the insulating layer include silicon oxide, silicon nitride, aluminum oxide, barium titanate, barium zirconium titanate and the like; illustrative examples of organic polymers for the insulating layer include polyesters, polycarbonates, poly(vinyl phenol), polyimides, polystyrene, poly(methacrylate)s, poly(acrylate)s, epoxy resin and the like. The thickness of the insulating layer is, for example from about 10 nm to about 500 nm depending on the dielectric constant of the dielectric material used. An exemplary thickness of the insulating layer is from about 100 nm to about 500 nm. The insulating layer may have a conductivity that is for example less than about 10⁻¹² S/cm.

Situated, for example, between and in contact with the insulating layer and the source/drain electrodes is the semiconductor layer wherein the thickness of the semiconductor layer is generally, for example, about 10 nm to about 1 micrometer, or about 40 to about 100 nm. Any semiconductor material may be used to form this layer. Exemplary semiconductor materials include regioregular polythiophene, oligthiophene, pentacene, and the semiconductor polymers disclosed in U.S. Pat. Nos. 6,621,099; 6,770,904; and 6,949,762; and “Organic Thin Film Transistors for Large Area Electronics” by C. D. Dimitrakopoulos and P. R. L. Malenfant, Adv. Mater., Vol. 12, No. 2, pp. 99-117 (2002), the disclosures of which are totally incorporated herein by reference. Any suitable technique may be used to form the semiconductor layer. One such method is to apply a vacuum of about 10⁻⁵ to 10⁻⁷ torr to a chamber containing a substrate and a source vessel that holds the compound in powdered form. Heat the vessel until the compound sublimes onto the substrate. The semiconductor layer can also generally be fabricated by solution processes such as spin coating, casting, screen printing, stamping, or jet printing of a solution or dispersion of the semiconductor.

The insulating dielectric layer, the gate electrode, the semiconductor layer, the source electrode, and the drain electrode are formed in any sequence, particularly where in embodiments the gate electrode and the semiconductor layer both contact the insulating layer, and the source electrode and the drain electrode both contact the semiconductor layer. The phrase “in any sequence” includes sequential and simultaneous formation. For example, the source electrode and the drain electrode can be formed simultaneously or sequentially. The composition, fabrication, and operation of thin-film transistors are described in Bao et al., U.S. Pat. No. 6,107,117, the disclosure of which is totally incorporated herein by reference. The silver nanoparticles can be deposited as a layer upon any suitable surface, such as the substrate, the dielectric layer, or the semiconductor layer.

### EXAMPLES

The following examples are for purposes of further illustrating the present disclosure. The examples are merely illustrative and are not intended to limit devices made in accordance with the disclosure to the materials, conditions, or process parameters set forth therein.

### Example 1

A mixture of 10 grams of silver acetate and 27.8 grams of dodecylamine in 15 milliliters of decalin and 2.5 milliliters of methanol was provided to a 250 milliliter reaction flask. The reaction flask was heated to about 50° C. for about 20 minutes with stirring under a nitrogen atmosphere. The mixture was then cooled to 40° C. A mixture of 3.56 grams of phenylhydrazine in 0.5 milliliters of methanol was slowly added to the mixture. The resultant mixture was further stirred for 1.5 hours at 40° C. 50 milliliters of methanol was added and the product was precipitated. After the mixture was stirred for about 10 minutes, the precipitate was filtered and then stirred in 15 milliliters of methanol in a 100 milliliter beaker for 30 minutes. The resulting product was collected by filtration and dried under a vacuum overnight at room temperature, yielding 6.7 grams of silver nanoparticles.

### Example 2

A solution of the silver nanoparticles produced in Example 1 in 15 wt % toluene was prepared. A thin film of silver nanoparticles on a glass slide was obtained by spin-coating the solution on the slide. The thin film was heated on a hot plate at 110° C. for 10 minutes. The resultant thin film was shiny and mirror-like with a thickness of about 95 nanometers. Conductivity was measured using a conventional four-probe technique. The annealed silver film was very conductive with a high conductivity of 6.8×10⁴ S/cm. The coating solution of the silver nanoparticles was very stable over a two month period without precipitation.

### Example 3

A silver nanoparticle ink was prepared by dissolving 0.8 grams of silver nanoparticles produced in Example 1 in 1.2 grams of decalin. The solution was filtered through a 1 μm filter and comprised 40 wt % silver nanoparticles.

A set of thin lines on a glass substrate was obtained by inkjet printing using a Dimatix printer. The thin lines had lengths of 1 millimeter and 3 millimeters. The printed pattern on the glass was then heated on a hot plate at 80° C. for 20 minutes. Conductive lines having a thickness of about 150 nanometers and a width of about 50 μm were formed. The annealed lines exhibited a high conductivity of 1.92×10⁵ S/cm.

### Example 4

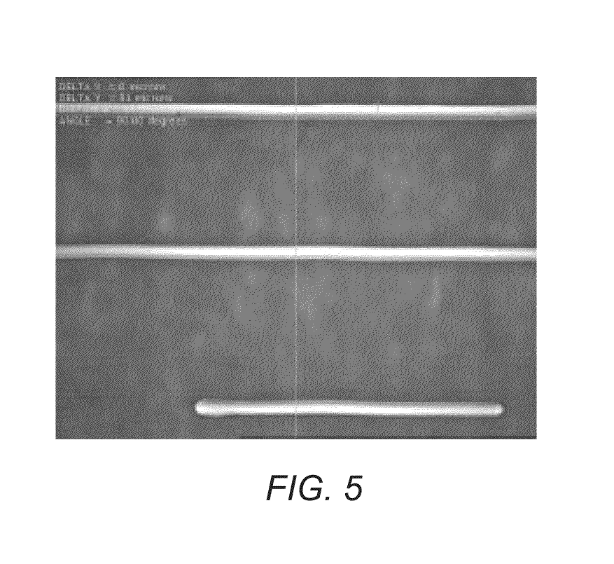

The 40 wt % silver nanoparticle ink described in Example 3 was allowed to age for 3.5 months and then was tested for stability by Dimatix inkjet printing. Lines were printed on a glass substrate without difficulty. The lines were very smooth and did not include black spots typically caused by particle aggregation. The lines are shown in FIG. 5. After annealing on a hot plate at 80° C. for 20 minutes, the resulting conductive lines had an average thickness of about 155 nanometers and an average width of about 60 μm. The conductivity was similar to the conductivity of the fresh ink tested in Example 3. This excellent ink stability indicates that silver nanoparticles produced by the disclosed process are very stable and do not experience significant aggregations or other kinds of degradations.

### Example 5

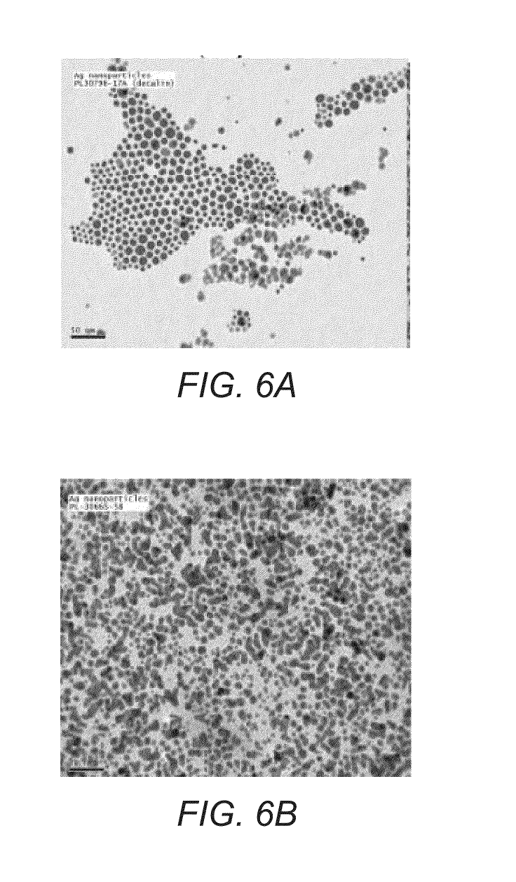

The nanoparticles produced in Example 1 were studied with TEM and compared to nanoparticles produced by a solvent-free process. In the solvent-free process, the stabilizer acted as the solvent. Those silver nanoparticles were precipitated out in methanol and collected by filtration. FIG. 6A represents the silver nanoparticles prepared by the disclosed process while FIG. 6B represents the silver nanoparticles prepared using the single solvent process. In these two pictures, red particles were selected for data analysis, and black particles were not selected for data analysis. The red particles had a roundness of 0.9-1.2 (spherical=1.0) and a mean diameter of between 2 nm-15 nm. This threshold ensured that only distinct silver nanoparticles were considered, and excluded agglomerated silver. This provided a standard measuring technique for a direct comparison of mean particle size between different samples.

The silver nanoparticles prepared using the disclosed process showed a much rounder and more uniform shape. The silver nanoparticles of FIG. 6A exhibited an average particle size of about 7.5 nanometers with a standard deviation of only 2.2 nanometers. On the other hand, the silver nanoparticles produced by the other process and seen in FIG. 6B had an average particle size of about 7.7 nanometers with a standard deviation of 4.3 nanometers. It should also be noted that there was a much higher proportion of agglomerates in FIG. 6B, the solvent-free process. These agglomerates are not useful, for example, in making a conductive element.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

1. A process for producing organoamine-stabilized silver nanoparticles, comprising:
receiving a first mixture comprising a silver salt, an organoamine, a first organic solvent, and a second organic solvent; and
reacting the first mixture with a reducing agent to form organoamine-stabilized silver nanoparticles;
wherein the first solvent has a polarity index of 3.0 or lower, and the second solvent has a polarity index higher than 3.0.

2. The process of claim 1, wherein the first solvent has a polarity index of 2.5 or lower, and the second solvent has a polarity index of 3.5 or higher.

3. The process of claim 1, wherein the difference in the polarity index between the first solvent and the second solvent is at least 2.0.

4. The process of claim 1, wherein the first solvent is a hydrocarbon selected from the group consisting of decalin, toluene, xylene, bicyclohexyl, and mixtures thereof.

5. The process of claim 1, wherein the second solvent is selected from the group consisting of methanol, ethanol, n-propanol, isopropanol, n-butanol, isobutanol, methyl ethyl ketone, ethyl acetate, tetrahydrofuran, 1,4-dioxane, and mixtures thereof.

6. The process of claim 1, wherein the first solvent is decalin and the second solvent is methanol.

7. The process of claim 1, wherein the volume ratio of the first solvent to the second solvent in the first mixture is from about 1:1 to about 10:1.

8. The process of claim 1, wherein the organoamine is selected from the group consisting of propylamine, butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, N,N-dimethylamine, N,N-dipropylamine, N,N-dibutylamine, N,N-dipentylamine, N,N-dihexylamine, N,N-diheptylamine, N,N-dioctylamine, N,N-dinonylamine, N,N-didecylamine, N,N-diundecylamine, N,N-didodecylamine, methylpropylamine, ethylpmpylamine, propylbutylamine, ethylbutylamine, ethylpentylamine, propylpentylamine, butylpentylamine, triethylamine, tripropylamine, tributylamine, tripentylamine, trihexylamine, triheptylamine, trioctylamine, 1,2-ethylenediamine, N,N,N′,N′-tetramethylethylenediamine, propane-1,3-diamine, N,N,N′,N′-tetramethylpropane-1,3-diamine, butane-1,4-diamine, N,N,N′,N′-tetramethylbutane-1,4-diamine, and mixtures thereof.

9. The process of claim 1, wherein the reaction occurs at a temperature of from about −30° C. to about 65° C.

10. The process of claim 1, wherein the reducing agent is a hydrazine compound.

11. The process of claim 10, wherein the hydrazine compound is of the formula:
R¹R²N—NR³R⁴
wherein R¹, R², R³, and R⁴ are independently selected from hydrogen, alkyl, and aryl.

12. The process of claim 1, wherein the molar ratio of the organoamine to the silver salt in the first mixture is from about 1:1 to about 10:1.

13. The process of claim 1, wherein the silver salt is selected from the group consisting of silver acetate, silver nitrate, silver oxide, silver acetylacetonate, silver benzoate, silver bromate, silver bromide, silver carbonate, silver chloride, silver citrate, silver fluoride, silver iodate, silver iodide, silver lactate, silver nitrite, silver perchlorate, silver phosphate, silver sulfate, silver sulfide, and silver trifluoroacetate.

14. The process of claim 1, wherein the standard deviation of the particle size of the organoamine-stabilized silver nanoparticles is less than about 3 nm.

15. The silver nanoparticles produced by the process of claim 1.

16. The silver nanoparticles of claim 15, wherein the silver nanoparticles have an average particle size of from about 3 nm to about 10 nm.

17. The silver nanoparticles of claim 15, wherein the standard deviation in size of the silver nanoparticles is less than about 3 nm.

18. A process for producing a conductive element, comprising:
receiving a first mixture comprising a silver salt, an organoamine, a first organic solvent having a polarity index of 3.0 or lower, and a second organic solvent having a polarity index higher than 3.0;
reacting the first mixture with a reducing agent to form organoamine-stabilized silver nanoparticles;
depositing the organoamine-stabilized silver nanoparticles on a substrate; and
annealing the deposited organoamine-stabilized silver nanoparticles at a temperature of from about 60° C. to about 140° C. to produce the conductive element.

19. The process of claim 18, wherein the annealing temperature is from about 60° C. to about 80° C.

20. The process of claim 18, wherein the first solvent is a hydrocarbon selected from the group consisting of decalin, toluene, xylene, bicyclohexyl, and mixtures thereof; and the second solvent is selected from the group consisting of methanol, ethanol, tetrahydrofuran, and mixtures thereof.
